(19) United States
(12) Patent Application Publication
(10) Pub. No.: US 2024/0086800 A1
(43) Pub. Date: Mar. 14, 2024

(54) E-commerce scheduled order apparatus and method

(71) Applicant: Corby Hammond, Lewiston, ID (US)

(72) Inventor: Corby Hammond, Lewiston, ID (US)

(21) Appl. No.: 18/467,710

(22) Filed: Sep. 14, 2023

Related U.S. Application Data
(60) Provisional application No. 63/406,500, filed on Sep. 14, 2022.

(51) Int. Cl. G06Q 10/0631; G06Q 10/083; G06Q 30/0601

(52) U.S. Cl. CPC G06Q 10/06312; G06Q 10/083; G06Q 30/0631; G06Q 30/0637

(57) ABSTRACT

A computer network and method for placing, processing, and fulfilling orders for scheduling the delivery of ordered goods and services with particular applicable applicability to defined delivery dates.

### CROSS-REFERENCE TO RELATED APPLICATIONS

This application claims priority to pending provisional application 63/406,500 filed on Sep. 14, 2022.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TOA “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable

### STATEMENT REGARDING PRIOR DISCLOSURES BY AN INVENTOR OR JOINT INVENTOR

Not Applicable

### BACKGROUND OF THE INVENTION

In the early days of mail-order catalogs, a customer could obtain a physical catalog, place an order by telegraph, telephone, or mail, and wait an indeterminate time for the item(s) to be either delivered or available for local pick-up. Since then, shipping logistics have progressed greatly allowing much more certainty about when something will be delivered, often down to the day and an interval of several hours, depending on the contracted service. This delivery determination often takes into account a wide variety of factors including, but not limited to, the warehouses stocking the item(s), the delivery service speed requested, the available delivery vendors, the destination address (business or residential), and even weather and road conditions.

For many years, people purchased gifts at retail stores, wrapped them, attached a card, and then took them to social gatherings such as birthday parties. This ensured gifts were timely delivered. For certain large events, such as weddings, the person, or people, being celebrated sometimes created a registry listing items they desired. Guests could view this registry at a store, purchase items to give which had not yet been purchased at the store, and indicate the item was being purchased toward a particular registry. This reduced the duplication of gifts by tracking which gifts had been purchased. With the increasing prevalence of e-commerce, more gifts are purchased on-line and sent directly to the recipient. E-commerce has enabled customers to shop from a wider variety of vendors than were likely available in their respective geographic areas.

### DESCRIPTION OF RELATED ART INCLUDING INFORMATION DISCLOSED UNDER 37 CFR 1.97 AND 37 CFR 1.98

Not Applicable

### BRIEF SUMMARY OF THE INVENTION

A computer network and method for ordering and fulfilling orders for scheduling the delivery of ordered goods and services.

### BRIEF DESCRIPTION OF THE SEVERAL VIEWS OF THE DRAWING

FIG. 1 shows a method of receiving and queuing orders of the present invention

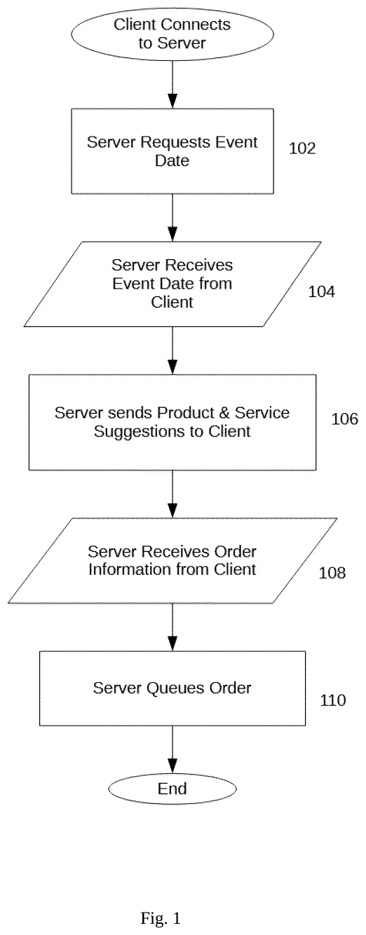

FIG. 2 shows a method of suggesting products and services to a client the present invention.

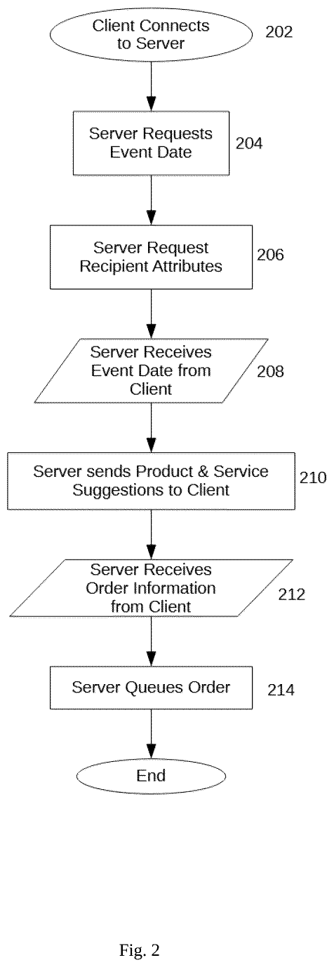

FIG. 3 shows a method of suggesting products and services to a client the present invention.

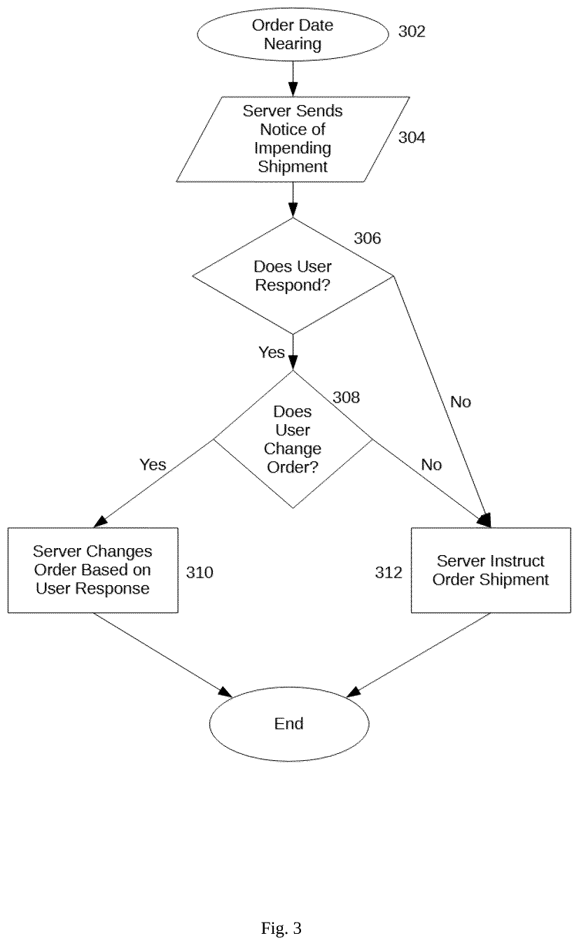

FIG. 4 shows a method of adjusting product or shipping pricing based on available shipping modes required to meet a delivery date of the present invention.

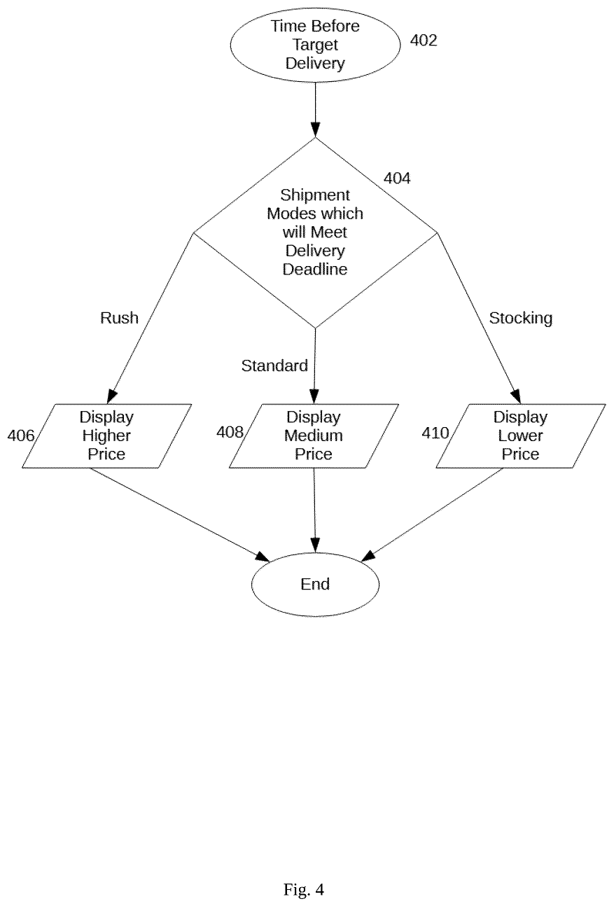

FIG. 5 shows a method of shipping an order to meet a specific delivery window of the present invention.

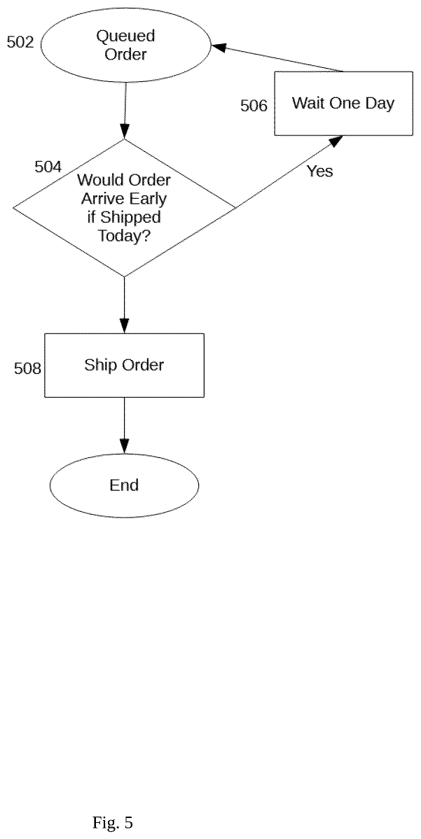

FIG. 6 shows a computer network of the present invention.

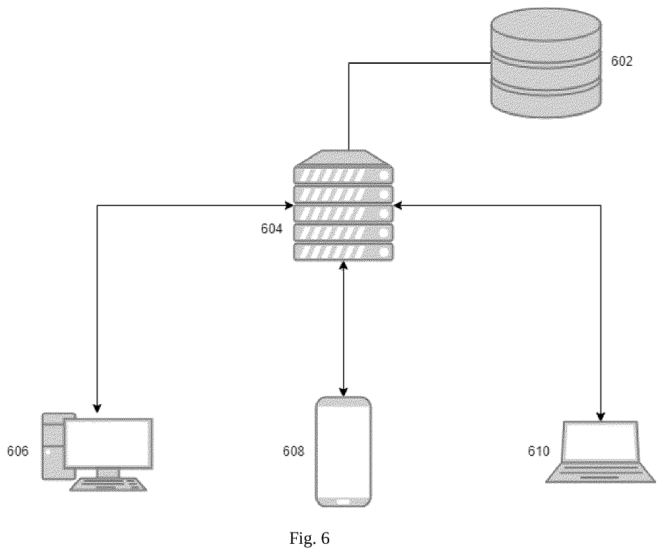

### DETAILED DESCRIPTION OF THE INVENTION

The present invention is a computer system and method for ordering and fulfilling orders for goods and/or services. The invention has particular applicability for goods or services which a person desires to arrive at or near a particular date/time. In a preferred embodiment, the computer system comprises one or more servers 604 configured to accept, store, and process data and one or more clients 606, 608, and 610 configured to send data to, and receive data from, the servers. In a preferred embodiment, the server(s) 604 and client(s) 606, 608, and 610 are connected via the internet. The server(s) 604 is/are preferably configured with software instructions on a computer readable medium 602 configured to instruct the server 604 to send information to the client(s) 606, 608, and 610 such that a person using a client device 606, 608, or 610 may enter required information. This required information preferably includes, but is not limited to, the following: account information, payment information, retailer information, item(s) to be purchased, recipient information, and desired delivery date. The server(s) 604 is/are preferably further configured with software instructions on a computer readable medium 602 configured to instruct the server 604 perform operations on a user-defined schedule.

In a preferred process, a user uses a client device 606, 608, or 610 to access the server 604 across the internet. The client(s) 606, 608, and 610 is/are preferably configured with software instructions on a computer readable medium configured to instruct the client 606, 608, and 610 to interpret information received from the server 604 and present the user with a user interface whereby the user may enter information to be sent to the server 604. If the user has not previously used the system, the system preferably prompts the user to create an account such that information entered and created by the user may be securely stored and retrieved across a variety of client devices 606, 608, and 610. If the user has previously used the system, the user may be automatically logged on or the user may be presented with an opportunity to log on 202. When logged on, a user is preferably presented with various means to browse and select goods to purchase. These means include, but are not limited to, a list of suggested goods and/or services 106, a directory of retailers/service providers, and a directory of goods or services. In a preferred embodiment, the user is also presented with the opportunity to create recipient profiles. Information in these recipient profiles preferably includes, but is not limited to, name, nickname, sex, religion, size, interests, shipping address, telephone number, and important dates (such as birth date, anniversary date, holidays, etc.). A user may place an order 108, 212 for a good or service to be delivered to a recipient. In a preferred embodiment, the user may select a date 102 and 104, or range of dates, for the desired good(s) or service(s) to be delivered.

Using the system, a user may create profiles for a plurality of recipients. In a preferred embodiment, the system suggests possible gifts based on information entered in a recipient profile. The server(s) 604 are preferably configured with instructions to suggest goods or services 106 to purchase. For example, if other users have frequently bought sports equipment for recipients of a similar sex and age 206, the system may list sports equipment as a suggested gift for a particular recipient 210. Suggested goods may be based on the time of year of scheduled delivery 204. For example, if a recipient has a birthday in August 208, the system might select pool toys as a birthday gift. Suggested goods may also be based on location. If a recipient is indicated to live at a geographic location regarded for hunting and fishing, the system may suggest geographically relevant goods such as a fishing pole. Suggested goods may also be based on past history. For example, if a user purchased a fishing pole for a particular recipient, the system may suggest a tackle box for a subsequent purchase. Suggestions may be based upon data collected within the system (e.g. purchases by other users of the system), or be based on information collected outside the system. A wide variety of suggested based upon one or more attributes in a user and/or recipient profile are anticipated in various embodiments of the present invention.

In one embodiment, the system organizes suggestions by urgency, that is, in ascending order of date (such as recipient birth date, recipient anniversary, etc.). In another embodiment, the system organizes suggestions for various recipients by urgency based on shipping logistics accounting for likely delivery times. For example, if an item for a recipient would have to be shipped internationally, anticipated customs and shipping times may be used to anticipate when an order must be placed to assure delivery by a desired date.

In one embodiment of the present invention, the price of the good, or shipping price, may be adjusted based on shipping modes 404 or cost to achieve a particular delivery date 402. If an expedited shipping method, such as air freight, is required, a higher price 406 may be shown. If a normal shipping method, such as ground freight, will suffice, a medium price 408 may be shown. If a slower shipping method will suffice, such as a stocking order, a lower price 410 may be shown.

A user may shop for a number of recipients and/or multiple delivery dates at a single time, schedule deliveries 110, 214 for the desired time (such as in the days immediately preceding a birthday, and be reasonably assured items will be delivered when desired. This is preferably achieved by the order system queuing orders 502. The system preferably routinely examines queued orders against available shipping modes to determine whether shipping an order would cause it to arrive when desired 504. If so, the order is shipped 508. If not, order remains queued and it is examined at a later date 506. In a preferred embodiment, the user is billed for goods or services when items are shipped. In an alternative embodiment, the user is billed for the goods or services when items are ordered. In a preferred embodiment, the system provides a user with various configurable notifications. These notifications may include, but are not limited to the following: order confirmation, pre-shipment notifications 304, billing notifications, shipment/delivery notifications, important date reminder notifications, and payment mode expiration notifications.

In a preferred embodiment, a user may include information for a customized note or message to be included with delivered goods or services. In certain embodiments, customized notes or messages may be ordered independent of the purchase of other goods or services.

In a preferred embodiment, the system is configured to accept recurring orders. For example, a user may place an order for batteries to be delivered monthly, or for a good or service to be delivered/provided weekly. The system is applicable to a wide variety of goods and services. These goods may include, but are not limited to, gift items, food, alcohol, flowers, gift baskets, grocery items, and prepared food. Services may include seasonal property maintenance, food preparation services, and any other of a wide variety of services which may be desired to be performed on a schedule.

The system benefits users by helping ensure goods are delivered at the correct time. The system benefits retailers by allowing them to use slower and less expensive shipping modes since many orders may be placed significantly in advance 110, 214. The system benefits service providers by providing scheduling and demand information for requested services. The system benefits shipping logistics providers by allowing them early information on likely upcoming parcels counts and destination.

Unless otherwise clearly indicated, quantities are exemplary. The expression of one quantity is not exclusive of other quantities. For purposes of this disclosure, including claims, plurality means one or more.

1. An apparatus for accepting and fulfilling orders comprising:
A) a server computing apparatus with a computer readable medium configured to instruct the server to:
i) send information to a client computing apparatus requesting event date information for a recipient,
ii) receive the event date information from the client computing apparatus,
iii) send product and/or service suggestions for a recipient to the client computing apparatus,
iv) receive order information for a product and/or service from the client computing apparatus, and
v) queue an order for the gift to be delivered to the recipient to arrive approximately on the event date.

2. The apparatus of claim 1 wherein the computer readable medium is further configured to instruct the server to:
A) accept information regarding a recipient upon which product and/or service suggestions may be based.

3. The apparatus of claim 2 wherein:
A) product and/or service suggestions criteria include the ability of the product and/or service provider to deliver or provide the product and/or service by the event date.

4. The apparatus of claim 3 wherein the computer readable medium is further configured to instruct the server to:
A) send a notification to the client computing apparatus of an upcoming event date.

5. The apparatus of claim 4 wherein:
A) said notification is sent before an ordered plurality of items is scheduled to be shipped to confirm the order before the ordered plurality of items is shipped.

6. The apparatus of claim 5 wherein the computer readable medium is further configured to instruct the server to:
A) accept order changes from the client computing apparatus.

7. The apparatus of claim 6 wherein:
A) said order changes comprise one or more of the following: order cancellations, order additions, delivery location changes.

8. A computer implemented method comprising:
A) sending information to a client computing apparatus requesting event date information for a recipient,
B) receiving the event date information from the client computing apparatus,
C) sending product and/or service suggestions for a recipient to the client computing apparatus,
D) receiving order information for an item from the client computing apparatus, and
E) queuing an order for a product and/or service to be delivered to the recipient and to arrive approximately on the event date.

9. The method of claim 8 further comprising:
A) accepting information regarding a recipient upon which product and/or service suggestions may be based.

10. The method of claim 9 wherein:
A) the product and/or service suggestion criteria include the ability of a product and/or service provider to deliver or provide the product and/or service by the event date.

11. The method of claim 10 further comprising:
A) sending a notification to the client computing apparatus of an upcoming event date.

12. The apparatus of claim 11 wherein:
A) said notification is sent before an ordered plurality of items is scheduled to be shipped to confirm the order before the ordered plurality of items is shipped.

13. The method of claim 12 further comprising:
A) accepting order changes from the client computing apparatus.

14. The method of claim 13 wherein:
A) said order changes comprise one or more of the following: order cancellations, order additions, delivery location changes.

15. A method of scheduling order delivery comprising:
A) prompting a user for an order wherein items available to be ordered are selected based upon the ability of the order to be fulfilled by a specific date provided by the user,
B) accepting an order from the user for one or more available item,
C) sending a confirmation to a user prior to initiation of a delivery process wherein the confirmation includes means by which a user may change the order,
D) receiving zero or more requested order option changes from the user,
E) changing order options based on changes, if any, requested by the user, and
F) scheduling delivery such that the order will be delivered approximately at the specific date.

16. The method of claim 15 wherein changes to the order are selected from a list comprising:
A) changing delivery address,
B) changing delivery date or delivery time,
C) changing the quantity of the ordered goods and/or services, and
D) changing the ordered goods and/or services.

17. The method of claim 15 wherein:
A) the price of ordered items is adjusted based on delivery costs such that items are less expensive when slower, less costly delivery means are available and more expensive when faster, more costly deliver means are required to fulfill the order by the specific date.
